(19) United States
(12) Patent Application Publication
(10) Pub. No.: US 2023/0324060 A1
(43) Pub. Date: Oct. 12, 2023

(54) POLLUTANT REMOVING AIR GROOVE

(71) Applicant: COUNCIL OF SCIENTIFIC AND INDUSTRIAL RESEARCH, New Delhi (IN)

(72) Inventors: Satinder KAUR, WorliNaka, Worli, Mumbai Maharashtra (IN); Rakesh KUMAR, WorliNaka, Worli, Mumbai Maharashtra (IN)

(21) Appl. No.: 18/044,507

(22) PCT Filed: Sep. 13, 2021
(86) PCT No.: PCT/IN2021/050897

§ 371 Date: Mar. 8, 2023

(30) Foreign Application Priority Data
Sep. 12, 2020 (IN) 202011039588

(51) Int. Cl. F24F 8/175; B01D 53/85; A01G 31/02

(52) U.S. Cl. CPC F24F 8/175; B01D 53/85; A01G 31/02

(57) ABSTRACT

An air purification system with specific plants having microbes on rhizosphere/roots capable of removing pollutants from a surrounding environment. The system has a plurality of axial fans provided at an inlet and an outlet to facilitate flow of polluted air in and clean air out. The system has a perforated plate for collecting water in a water tank. The water tank with pump are for regular watering of the plants. The system has a pipe and nozzles for spraying of water with nutrients and a sensor for detecting pollutants. The system is capable of reducing a wide range of pollutants, such as particulate matter, volatile organic compounds (VOCs), sulfur oxides (SOx) and nitrogen oxides (NOx).

### FIELD OF INVENTION

The present invention relates to the field of air purification and more particularly to a passive air purification system.

### BACKGROUND OF INVENTION

Indoor Air Pollution (IAP) refers to chemical, biological and physical contamination of indoor air. According to USEPA indoor pollution has exceeded two to three times than outdoor pollution thereby deteriorating quality of life. Indoor air quality term refers to the air quality within and around buildings and structures, especially as it refers to the health and comfort of building occupants. IAP has been ranked among top ten risk factors and has become a cause of concern. According to WHO, 4.3 million people a year die from the exposure to household air pollution. It has resulted into Sick Building Syndrome (SBS), Building Related Illness (BRI) and Multiple Chemical Sensitivity (MCS). Some health effects are short term which may show up shortly after a single exposure to a pollutant. These include irritation of the eyes, nose, and throat, headaches, dizziness, and fatigue. Other health effects are long term such as respiratory diseases, heart disease and cancer which may show up either years after exposure has occurred or only after long or repeated periods of exposure.

IAP is a concern in both developed as well as developing countries. In developed countries improvement in energy efficiency has resulted into tightly sealed buildings reducing ventilation and raising pollutant levels. Whereas, in developing countries different conditions are responsible for IAP. In rural areas people are mostly dependent on traditional fuels such as firewood, charcoal, and cow dung for cooking and heating. Burning such fuels produces large amount of smoke and other air pollutants in the confined space of the home, resulting in high exposure. In urban areas, exposure to IAP has increased due to a variety of reasons, including the construction of more tightly sealed buildings, reduced ventilation, use of synthetic materials for building and furnishing and use of chemical products. IAP can begin within the building or be drawn in from outdoors. The most common pollutants are particulate matter, volatile organic compounds, pollen, molds, asbestos, radon.

Control of indoor pollution can be done by source control or by improving ventilation system. Air-cleaning methods include adsorption, absorption, ozonation, catalytic oxidation etc. However, these technologies have been found to be effective only when VOCs concentrations are at relatively high levels and releases harmful by-products. But removal of these harmful by-products is still an issue need to be solved. Most of the research on biological treatment such as biofilters, bio-trickling filters had been carried out in order to develop an important alternative to many physical and chemical techniques for the treatment of VOCs. The advantages of this technology over other air cleaning methods is biological processes are readily accepted as an environment friendly process. But low treatment efficiency at high concentrations of VOCs, extremely large sizes of bioreactor challenges space constraints, packing has a limited life, clogging of the medium due to particulate medium may add to some of the drawbacks.

Recently through many research studies it has been proved that the plants have capability to remove pollutants from indoor air and is a cost effective method. Also plants rhizospheric bacterial communities are found to be responsible for removal of pollutants. It has been illustrated by the fact that when the plants are removed from the media, the pollutants continue to decrease. Therefore, combination of plants with active removal method is used to clean the air.

The above information is presented as background only to help the reader for understanding the present invention. Applicants have made no determination and make no assertion as to whether any of the above might be applicable as Prior Art with regard to the present application.

### OBJECTIVES OF INVENTION

1) The principle object of the embodiments herein is to provide an air purification system and apparatus by using aeroponic system.
2) Another object of the embodiments herein is to provide an air purification system which includes a specific plants or set of plants such as Peperomia capperata, Peperomia capperata variegata, Peperomia sandersii, Maranta leuconeura, Maranta cinza, Alocasia amazonica, Alocasia macorrhiza variegated, Calathea zebrina, Calathea roseopicta, Crassula ovata, Crassula argenta, Pilea microphylla, Pilea spruceana, Philodendron xanadu, Dracaena mahatama, Sansevieria cylindrica, Savia splendens, Alpinia zerumbet, Brassica oleracea, Pandanus tectonus, Coleus blumei, Excoecaria cochinchinensis, Tradescantia zebrina, Kalanchoe tomentosa, Beaucarnea recurvata to remove pollutants from air around the unit. The applicant has applied for NBA approval.
3) Another object of the embodiments herein is to provide a plurality of axial fans connected to the inlet and outlet of the purifier to generate a flow force for passing air through the roots.
4) Another object of the embodiments herein is to provide a support to keep plants without movement and getting uprooted.
5) Another object of the embodiments herein is to provide a water tank for watering.
6) Another object of embodiments herein is to provide pipe and nozzles to spray water containing nutrients.
7) Another object of embodiments herein is to provide motor for pumping water from the water tank.
8) Another object of embodiments is to provide metal sheet below plants to collect water back into the water tank for recycling.
9) Another object of the embodiments is to provide sensors for detecting the pollutant level (VOCs, CO, SOₓ, NOₓ, PM).
10) Another object of embodiments herein is to provide effective cleaning of specific pollutants such as VOCs, CO, SOₓ, NOₓ, PM.

### SUMMARY

Accordingly, the embodiments herein provide a system and apparatus for air purification following aeroponic technology. The proposed system consists of a specific plants or set of plants such as Peperomia capperata, Peperomia capperata variegata, Peperomia sandersii, Maranta leuconeura, Maranta cinza, Alocasia amazonica, Alocasia macorrhiza variegated, Calathea zebrina, Calathea roseopicta, Crassula ovata, Crassula argenta, Pilea microphylla, Pilea spruceana, Philodendron xanadu, Dracaena mahatama, Sansevieria cylindrica, Savia splendens, Alpinia zerumbet, Brassica oleracea, Pandanus tectonus, Coleus blumei, Excoecaria cochinchinensis, Tradescantia zebrina, Kalanchoe tomentosa, Beaucarnea recurvata capable of removing pollutants (VOCs, CO, SOₓ, NOₓ, PM) from air around the filtration unit. The plants are given support and the roots are allowed to hang freely through which air is passed. The proposed system includes a plurality of axial fans for generating a flow force for passing air through the roots. The proposed system includes a water tank and a pump for watering. The proposed system includes a motor for pumping of water. The proposed system includes pipe and nozzles for spraying of water with nutrients. The proposed system includes metal sheet for collecting water into the water tank for recycling. The proposed system includes sensor for detecting pollutant level (VOCs, CO, SOₓ, NOₓ, PM). These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiment herein without departing from the spirit thereof, and the embodiment herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIGS. 1 and 2 illustrates an air purification system; specific plants (1); rhizosphere/roots (2); plurality of axial fans (3); water tank (8); pump (7); pipe (6); nozzles (4); sensor (5) electricity through solar panel (10) or wind energy.

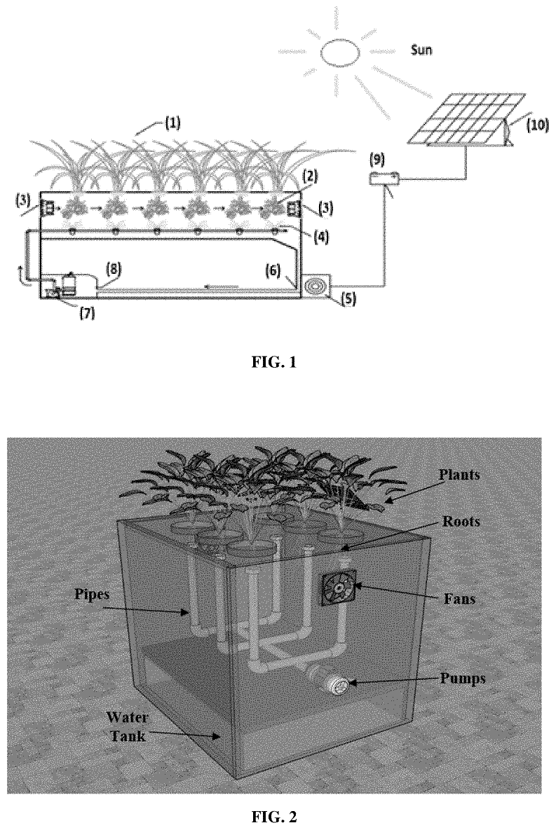

FIG. 3 is Percent reduction of benzene, toluene, ethylbenzene, xylene, and BTEX

### DETAILED DESCRIPTION OF INVENTION

Pollutant Removing Air Grove (PRAG) works on aeroponic technique consisting of specific plants (1) having microbes on rhizosphere/roots (2) capable of removing pollutants from surrounding. A plurality of axial fans (3) at inlet and outlet are provided to facilitate flow of polluted air in and clean air out. The proposed system includes a water tank (8) with pump (7) for regular watering of the plants. The proposed system includes pipe (6) and nozzles (4) for spraying of water with nutrients. The proposed system includes a sensor (5) for detecting pollutants. The electricity will be provided through solar panel (10) or wind energy.

The present invention Pollutant Removing Air Grove (PRAG) provides an air purification system and apparatus for indoor as well as outdoors. The proposed system includes a specific plant or set of plants capable of removing pollutants from air around the filtration units based on aeroponic technique. The proposed system includes a plurality of axial fans both at inlet and outlet for generating a flow force for passing air through exposed roots of the plant hanging from the support. The proposed system includes a water tank and a pump for watering. The proposed system includes pipe and nozzles for spraying of water with nutrients. The purposed system consists of a perforated plate for collecting water into the water tank with the help of pipe. The proposed system consists of a sensor for detecting pollutant level. The combination of the plants, and the axial fan in the proposed system can be referred to as filtration unit. The proposed system allows the integration and installation of sophisticated sensors, which can detect the concentration of the pollutants in the atmospheric air. Thus, the system starts when the pollution levels exceed safe limits and turns off when the pollution levels are within safe limits; thereby saving energy or reducing power consumption. The proposed system can also function using other forms of renewable energy sources such as wind and solar.

The following examples are given by way of illustration of the present invention and therefore should not be construed to limit the scope of the present invention.

### Examples

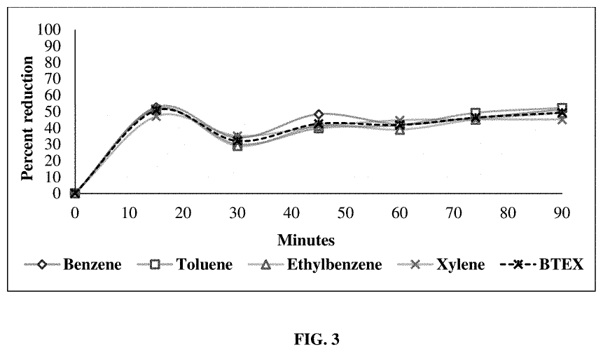

Experiments were performed in the environmental chamber (9.72 m3 in volume) with internal environmental condition 51±0.3% RH and 27±0.2° C. It was operated at full recirculation mode with air exchange rate of 27.5 ACH. The initial concentration of 30 ppm of benzene, toluene, ethylbenzene, and xylene and 100 ppm of BTEX mixture were injected in the chamber. From the FIG. 3 it is clear that, PRAG is showing 45-52% reduction during 90 mins of test period, where benzene is showing 51%, toluene 52%, ethylbenzene 49% and xylene 45% of reduction. Mixture of these VOCs i.e. BTEX had shown 49% reduction. In the NYSERDA Report, 2010 experimental test were performed on the modified dynamic botanical air filter actually developed by Wolverton. With the plants, the filter system had higher initial removal efficiency of only 33% for toluene.

In order to find out the cleaning ability of the air cleaner, quantifying CADR is the effective method. It is a measure of air cleaners delivery of contaminant free air expressed in cubic feet per minute. In this study PRAG had shown CADR ranging from 10.39-12.12, where toluene had shown highest delivery rate 12.12 and had xylene shown lowest delivery rate 10.39. Single pass efficiency (η) represented the fraction of pollutants removed from the air stream as it passed through the device. PRAG had shown single pass efficiency ranging from 44.5-51.9%%, where benzene 51.3% %, toluene 51.9% %, ethylbenzene 48.8% % and xylene 44.5%.

### Advantages

It addresses problems of indoor as well as outdoor pollution and can be used in households, schools, hospitals, basements, subways, commercial and corporate buildings, industrial complex and traffic junctions.

It can reduce wide range of pollutants such as particulate matter, VOCs, SOx. NOxIt uses sensors to detect level of pollutants in the surrounding.

It can use energy from renewable sources such as wind and solar.

1. An air purification system based aeroponic technique, said system comprising:
a. specific plants having microbes on rhizosphere/roots capable of removing pollutants from surrounding;
b. a plurality of axial fans at an inlet and an outlet provided to facilitate flow of polluted air in and clean air out;
c. a water tank with a pump for regular watering of the specific plants;
d. a perforated plate for collecting water in the water tank;
e. a pipe and nozzles for spraying of water with nutrients; and
f. a sensor for detecting pollutants.

2. An air purification system as claimed in claim 1, wherein the specific plants are selected from the group consisting of Peperomia capperata, Peperomia capperata variegata, Peperomia sandersii, Maranta leuconeuro, Maranta cinza, Alocasia amazonica, Alocasia macorrhiza variegata, Calathea zebrina, Calathea roseopicta, Crassula ovata, Crassula argenta, Pilea microphylla, Pilea spruceana, Philodendron xanadu, Dracaena mahatama, Sanseivera cylindrica, Savia splendens, Alpinia zerumbet variegata, Brassica oleracea, Pandanus tectonus, Coleus blumei, Excoecaria cochinchinensis, Tradescantia zebrina, Kalanchoe tomentosa, Beaucarnea recurvate;

3. An air purification system as claimed in claim 1, wherein the plurality of axial fans at the inlet and the outlet generate a flow force for passing air through exposed roots of the specific plants hanging from a support.

4. A method of removing pollutants from air comprising using the air purification system of claim 1, wherein the specific plants aeroponically remove the pollutants from air around the air purification system.

5. An air purification system as claimed in claim 1, wherein the perforated plate collects the water into the water tank with the help of pipe.

6. An air purification system as claimed in claim 1, wherein the purification system is provided with an energy source selected from the group consisting of a solar panel, wind energy and a conventional energy source.
